(19) United States
(12) Patent Application Publication
(10) Pub. No.: US 2019/0301885 A1
(43) Pub. Date: Oct. 3, 2019

(54) Method for Providing a Text-Based Description of at Least One Route for a Journey of a Motor Vehicle, as Well as a Control Device and Motor Vehicle

(71) Applicant: Volkswagen Aktiengesellschaft, Wolfsburg (DE)

(72) Inventors: Niels Lohmann, Berlin (DE); Volker Remuss, Berlin (DE)

(73) Assignee: Volkswagen Aktiengesellschaft, Wolfsburg (DE)

(21) Appl. No.: 16/469,354

(22) PCT Filed: Nov. 20, 2017
(86) PCT No.: PCT/EP2017/079821

§ 371 Date: Jun. 13, 2019

(30) Foreign Application Priority Data
Dec. 16, 2016 (DE) 10 2016 225 241.0
May 4, 2017 (DE) 10 2017 207 545.7

(51) Int. Cl. G01C 21/36

(52) U.S. Cl. CPC G01C 21/3641; G01C 21/3644

(57) ABSTRACT

The invention relates to a method for providing a text-based description of at least one route for a journey made by a motor vehicle, wherein: a control device determines route features in respective pre-defined surrounding areas comprising the route; at least some features from among the route features are selected for the description with the aid of a pre-defined selection criterion; the selected route features are arranged in an output order and an output hierarchy with the aid of a pre-defined sorting criterion and are entered in an output list; and a language text forming the description of the at least one route is produced from the output list by means of a text generation system on the basis of pre-defined language generation rules, and is output to a user.

### CROSS-REFERENCE TO RELATED APPLICATIONS

This application claims priority to German Patent Application No. DE 10 2016 225 241.0, filed on Dec. 16, 2016 with the German Patent and Trademark Office and to German Patent Application No. DE 10 2017 207 545.7, filed on May 4, 2017 with the German Patent and Trademark Office. The contents of the aforesaid applications are incorporated herein for all purposes.

### TECHNICAL FIELD

The invention relates to a method for providing a text-based description of at least one route for a journey of a motor vehicle. Such a description can be a written, natural language text, or a voice announcement. The invention also relates to a control device for performing the method. Finally, the invention also relates to a motor vehicle with such a control device.

### BACKGROUND

If a driver wishes to make a route plan during a journey with a motor vehicle, it may be provided that he enters the desired driving destination by a voice entry into a voice dialog system or by keyboard. If a route to the driving destination has then been calculated by the navigation system, the driver can then be given navigation instructions by voice output. However, there is a gap between the entry of the navigation goals (via keyboard or voice) and the subsequent language guidance announcements. The planned route or the selection from several possible routes is only graphically represented in a map and however not described summarily as text or announced. Moreover, differences arise between various alternative routes that for example are only graphically represented in the map by the type of route (fastest route, or shortest route, or most economical route). Routes differences that arise from explicit (for example by introducing an intermediate destination) or implicit replanning (for example by circumventing a jam) are not communicated. It is only announced that there has been a change in the route guidance.

A use of landmarks that the driver knows personally but do not have any general relevance to a route description is not employed. If for example a driver regularly goes to a certain restaurant, the restaurant can be cited as a landmark for orientation (such as: “make a right turn at restaurant XY”). Another example of such personal landmarks is the residence of a relative of the driver. Such personal landmarks would make it much easier for a driver to understand a description of a route.

On the Internet, there are map services such as Google Maps® that provide a text-based description for a calculated route for a journey that however are generally restricted to the length and duration of the route and are only available as a simple list of the roads to drive on. Outputting such a list as text or a voice announcement in a motor vehicle would overtax a driver in memorizing this description since the list entries do not fit in an overall description of the route; rather, they are insufficiently short and are incomprehensible without an additional graphic representation. (For example for a trip from Wolfsburg, Germany to Berlin Germany: “Take Braunschweiger Straße A 39, take the A2 and A 115 to Knobelsdorfstraße in Berlin, take the A 100 from the direction of Kaiserdamm and drive to B2/B5”). Accordingly, only the roads to drive are generally indicated without the landmarks as an orientation tool.

A navigation system is known from DE 10 2009 036 676 A1 for a vehicle that can automatically calculate a new route on a route in order to thereby guide a vehicle to a point of interest.

A method is known from DE 10 2010 006 702 A1 for calculating an alternative route in order to thereby optimize a trip duration and/or a route length of a route.

In a professional article by Münter and Hussein (Daniel Münter and Tim Hussein, “Adaptive Routenbeschreibung für Navigationssysteme” (Adaptive Route Description for Navigation systems), the journal i-com, 2011, DOI 10.1524/icom.2011.0003), several methods for personalizing a route description are known.

### SUMMARY

An object of the invention is to provide a natural language, text-based description for navigation assistance on at least one route for a journey by a motor vehicle.

This object is solved by the subject matter of the independent claims. Embodiments of the invention are described in the dependent claims, the following description, and the figures.

### BRIEF DESCRIPTION OF THE DRAWINGS

In the following, exemplary embodiments of the invention are described. In this regard:

FIG. 1 shows a schematic representation of an embodiment of a motor vehicle;

FIG. 2 shows a flow chart of an embodiment of the method for providing a text-based description or representation of at least one route for a journey of a motor vehicle;

FIG. 3 shows a sketch to illustrate a graph for a comparison of two routes;

FIG. 4 shows a sketch to illustrate a graph reduction, and

FIG. 5 shows a flow chart of another embodiment of the method for providing a text-based description or representation of at least one route for a journey of a motor vehicle.

### DETAILED DESCRIPTION

In one exemplary aspect, a method for providing a text-based description or representation of at least one route for a journey of a motor vehicle is provided. The method may be executed by a control device. Route features of the route are determined for each route in a respective predefined surrounding area comprising the route. Such a surrounding area may for example be defined as a correction of a predetermined width that is defined or provided on both sides of the route. By using a predetermined selection criterion, at least some of the features from the determined route features are selected for the description. First the totality of the route features available in the surrounding area are determined, and then a selection is made therefrom, wherein it may, e.g., be established by means of the selection criterion which of the route features are to be used for the description. Then by using a predetermined sorting criterion, the selected route features are arranged in an output order and an output hierarchy, and are entered into an output list. The output order indicates which route feature is mentioned after which other route feature to the user in the description. The output hierarchy establishes which route feature must be cited together with which other route feature. This solves a problem when some route features lie next to each other along the route, and it therefore must be made clear to the user in the description that these route features should not be expected sequentially. A route feature may for example be a road, another may for example be a location (city or town) that lies next to the road. It would then not make any sense to state in the description: “1. Road 2. Location”. Instead, should be explained to the user: “Drive along the road past the location”. Thus, the output hierarchy may establish that the location must be mentioned together with the road. The output list then serves as a basis for generating the text-based description. By means of a text generating apparatus, a language text is produced from the output list as the description of the at least one route on the basis of predetermined language generation rules. This language text is then output to the user. The language text may be structured such that it describes each route on the basis of the selection of the route features that were brought into an output order and output hierarchy. By means of the language generation rules, it may be ensured that each route feature is described according to its characteristics, i.e., a journey on the road is indicated for roads, and a journey past the landmark is described for landmarks (such as locations). The speech generation rules may be configured such that a natural-language text results, i.e., a text with complete grammatically correct sentences. A natural-language text is therefore a text that a person would also speak in an oral description.

The present aspect yields the benefit that the at least one route may be output to the user in the form of a natural language text, i.e., in the form in which another person would also describe the respective route to the user. By the selection of the route features, the output order and the output hierarchy, it is ensured that suitable route features for the description are output in an arrangement correctly describing the route so that the user may understand the course of the route.

The present aspect offers various embodiments, which result in additional benefits. Some embodiments are discussed in the following.

In some embodiments, each of the following may be determined as a route feature: A road, which the route follows, and a landmark that lies next to the road. A landmark is, e.g., understood to comprise a location that the route passes (for example a city, or a town, or a building, or a point of interest), a user-specific point of interest known to the user, and/or a maneuvering point on the route at which a road changeover and/or a road fork must be taken into account. A road accordingly may represent a route feature along which several other route features, i.e., landmarks, may be arranged. This may be important for the output hierarchy. A road may therefore be mentioned, and then at least one landmark subordinate in the output hierarchy may be mentioned along the road.

When selecting the route features from the totality of the available route features, it is in some embodiments provided that the selection criterion is configured to be parameterizable, and a level of detail and/or feature type is established for the selection depending on user input by the user. The level of detail establishes the overall resulting number of selected route features, wherein the number may be relative with respect to the length of the route. A feature type indicates which route features are selected. For example, a “road” feature type may establish that the road may be selected as the route feature, i.e., the respective road is mentioned in the language text. A “locations” feature type may indicate that locations that he/she is passing are mentioned to the user in the language text. A “personally known landmarks” feature type may establish that such landmarks that are personally known to the user are determined or selected based on an individual user profile of the user. Such a personal landmark may for example be a driving destination used in the past, and/or an address from an address list, and/or a point of interest mentioned and/or rated by the user in a social network (such as a restaurant or museum). By means of this feature type, the language text of the description of the least one route may obtain a personal reference for the user. It may be provided to establish more than one feature type for the selection.

In order to obtain a description by means of the selected route features that evenly covers the entire route with a given level of detail, it is in some embodiments provided for the selection of the route features that a distance to the driving destination and/or a provisional arrival time at the driving destination is always determined for the route features, and the selection criterion provides that the selected route features are arranged evenly along the respective route in terms of location and/or time. By “evenly”, it is meant in this context that the distance in terms of location and/or time between the route features lies within a predetermined tolerance interval. It may for example be provided to mention the route features every 5 to 15 minutes along the route of travel. The distance (in terms of location and/or time) may be adjusted depending on an overall length of the route.

With respect to the output order, the sorting criterion establishes in some embodiments that a temporal encountering sequence that results from the journey along the respective route corresponds to the output sequence. In addition or alternatively thereto and in some embodiments, said output hierarchy may hierarchically subordinate landmarks (for example a city or town or a point of interest) to a road on the route adjacent to the landmark, i.e., force a joint citation. This prevents the landmark from being mentioned before or after a road; instead, it is noted or stated in the description that the landmark was passed while driving on the adjacent road.

By means of the text generation apparatus, a written language text may in some embodiments be generated for display on a display apparatus, or a spoken language text may be generated for a voice announcement. The voice announcement has the advantage that, due to the development of the method, complete voice operation of a navigation assistance system is enabled since the driver may mention the driving destination in a voice dialog, then the user gets a description of the determined route and possibly a determined alternative route by a voice announcement, and subsequently the user may select or confirm a route by voice input. Then navigation instructions on this selected route may still be output by a voice announcement. The operation of a navigation system entirely by voice is therefore possible, and it is therefore unnecessary to look away from traffic events. The aforementioned “gap” is thereby closed.

In order to generate a suitable language text, some embodiments provide that the text generation apparatus sequentially processes the route features entered in the output list, and the language generation rules thereby provide prefabricated text fragments with predetermined text gaps, and the current route feature from the output list is inserted into the respective text gap in the current text fragment. For example, a text fragment may be provided as follows for the “road” route feature: “Drive along XXX”, wherein XXX may be a text gap for the name of the road that may then be taken from the output list in the form of the current route feature. A text fragment for a journey past a landmark may be: “Drive past YYY” wherein YYY is a text gap for the name of the landmark, i.e., such as a location name. The text fragments in this case are each selected depending on the output hierarchy and/or the feature type of the current route feature and/or the driving maneuver to be driven. A text fragment for an output hierarchy may for example comprise two route features, i.e., a road and a landmark that are passed along a road: “Drive past YYY on XXX!”.

By means of this method, it is also possible in some embodiments to produce a compact description of several routes. In order to produce a description for at least two routes and thereby compare or combine the two routes, it is in some embodiments provided to form a graph describing the two routes. A graph is a mathematical construct in which edges of the graph are connected by nodes of the graph. Each edge represents a section of the route, each node a connection of two sections. Such route sections that are common to both routes are always shown in the graphs as a common sequence (i.e., as a common edge or edge sequence) of the graph.

If the two routes differ, a pair of route sections therefore results, a route section per route in each case. In the graphs, such pairs of route sections, of which each route section belongs to only one of the two routes, may be inserted or arranged between a split node and a join node of the graph. A route may therefore have at least one common sequence that may divide into two different courses of edges (pairs of route sections) at a split node, and may recombine at a join node into a common sequence. The two routes may accordingly be jointly described thereby in that only a single language text for common sequences is produced, and only the differences are described separately. Moreover, it may thereby be recognized which part of the two routes must be described or output in each case for the user, i.e., the differences between the routes that may be recognized at a split node. A route with a common sequence is however not mandatory: If a sequence is missing, the split node corresponds to the starting point, and the join node to the destination point of the route.

By means of the text generation apparatus and in some embodiments, a common language text section of the language text for both routes is produced in order to produce the language text for a sequence of the graph (common route section), and a difference note for a split node is provided, and an individual language text section in the language text is then provided for divided route sections. A difference note may for example state: “Route A wants you to continue on road XXXX, whereas route B wants you to turn here.”

Such a comparison of the routes is in particular of benefit for starting a journey or navigation assistance, i.e., for the selection of one of the routes for the subsequent navigation assistance. In this case, the above-described example may be used in which a driver indicates a navigation destination by voice input, and then the calculated routes (such as the fastest route, shortest route, cheapest route) are presented or output to the user as language text. Another important area of use for the present embodiments results after a calculation of a new route due to a change in plan during a journey, or during navigation assistance. The route may then for example be replanned due to a jam so that a detour results as the new route. During the journey, the language text may then describe to the driver where the difference results between the previously planned route and the new route. This may be recognized by the resulting split node.

In order to execute the method discussed in the preceding, a further aspect provides a control device for a motor vehicle. The control device may have a processor apparatus which is configured to execute an embodiment of the method according to the preceding aspect. The processor apparatus may have a microcontroller or a microprocessor for this. The method steps may be configured as a program code of the processor apparatus that, while being run by the processor apparatus, executes the embodiment of the method according to the preceding aspect. The program code may be saved in a data memory of the processor apparatus.

Finally, a motor vehicle is provided in a further aspect that has an embodiment of the control device according to the preceding aspect. The motor vehicle may be designed as an automobile, in particular a passenger car or truck.

Another exemplary embodiment is explained in the following. In the exemplary embodiment, the described components of the embodiment represent individual features of the invention that should be considered independent of each other, and each also develop the invention independent from each other and should therefore be considered as within the scope of the invention both individually and in other than the portrayed combination. In addition, the described embodiment may also be supplemented by other features of the invention than those already described.

Elements having the same functions are, in each case, provided with the same reference numbers in the figures.

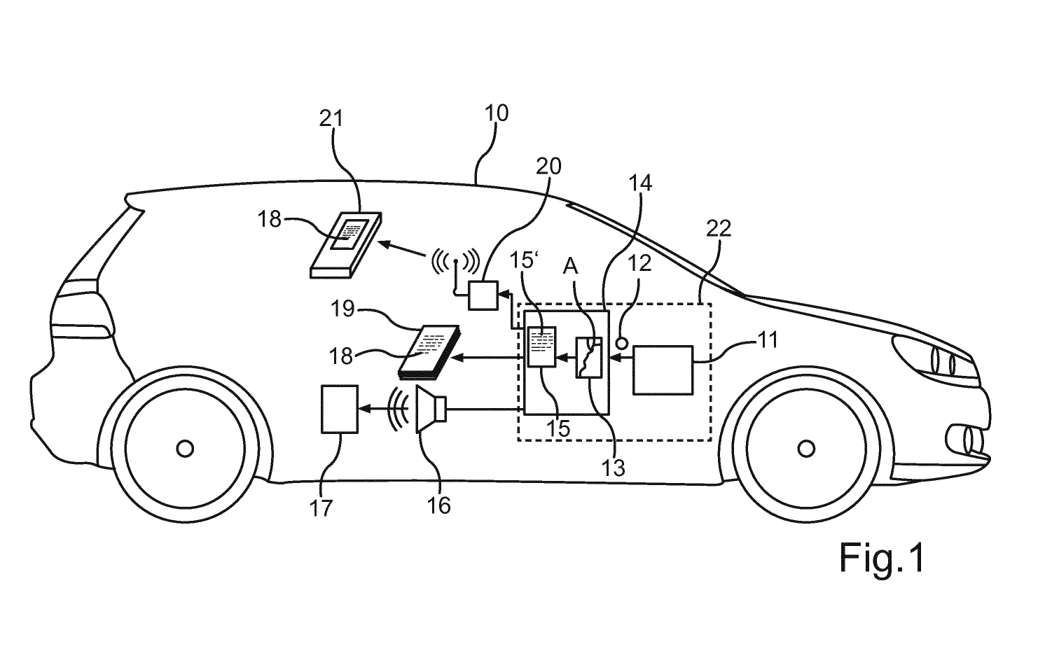

FIG. 1 shows a motor vehicle 10 that may be an automobile, in particular a passenger car or truck. In the motor vehicle 10, a navigating apparatus 11 may produce route data 12 that may describe a planned route A or a plurality of planned routes for a journey of the motor vehicle 10. The route A in this case is described for example by vector data, or by a mathematical graph 13 with nodes and edges. From this abstract or graph-based description of the route A, a control device 14 may produce a text-based description 15 with a language text 15′ which may be output to a user of the motor vehicle 10 as a natural language text. Accordingly, the control device 14 may for example produce a voice output 17 of the description 15 for example by means of an audio output apparatus 16 such as an audio system of the motor vehicle 10. A written description 18 on a display apparatus 19 of the motor vehicle 10 such as a screen or a head-up display may also be output. By means of a communication apparatus 20, the written description 18 may also be output on a mobile terminal 21 such as a smart phone of the user. The communication apparatus 20 may for example comprise a WLAN radio module (wireless local area network), or a mobile radio module. For example, the written description may be output as a message of an SMS (short message service).

The navigation apparatus 11 and the control device 14 may for example be a component of an infotainment system 22 of the motor vehicle 10 (infotainment system—information/entertainment system).

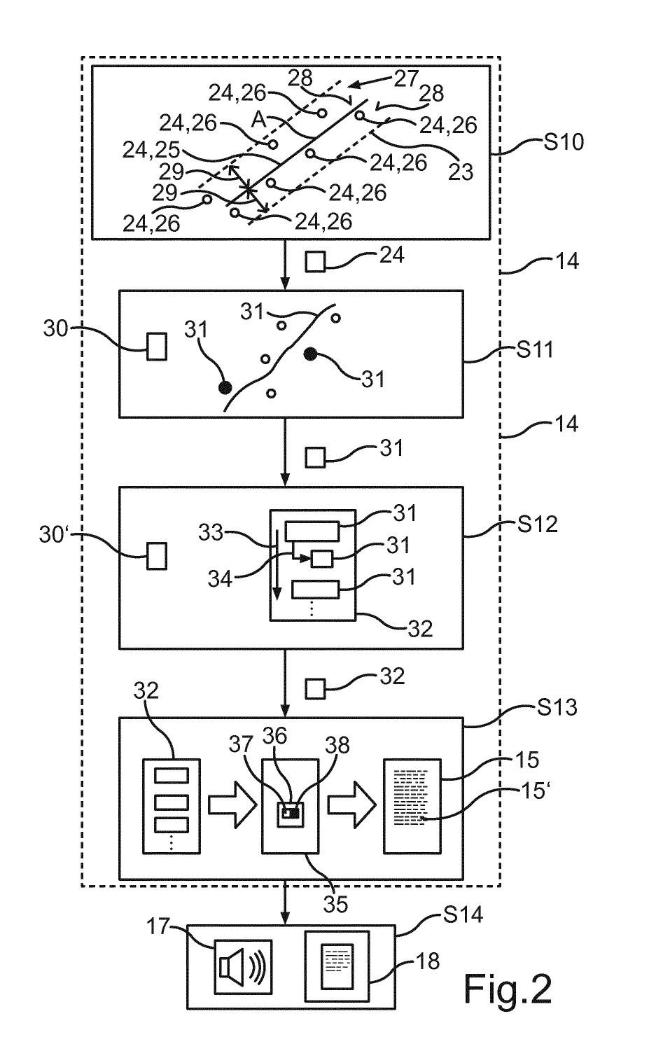

FIG. 2 illustrates how the text-based description 15 with the language text 15′ may be produced for a route A by the control device 14.

The steps described in the following may for example be executed by a program code or a program module for a program apparatus of the control device 14.

In a step of data aggregation S10, it may be determined which route features 24 are along the route A in a surrounding area 23 around the route A. A route feature 24 may be a road 25 of the route A or a landmark 26 that may be located next to a road 25. The surrounding area 23 may be defined as a correction 27 which is defined by a respective strip 28 with a predetermined width 29 to both the right and left next to the route A.

From the overall available route features 24, a selection is made in a data selection S11 step by means of a selection criterion 30 from the available determined route features 24 so that selected route features 31 result.

By means of the selected route features 31, an output list 32 is produced from the selected route features 31 by means of a sorting criterion 30′ in a sorting S12 step in which the route features are indicated in an output sequence 33 and an output hierarchy 34 so that the time sequence of naming the selected route features 31 and the combined naming of for example a road 25 are sorted with a landmark 26 adjacent thereto.

Using the selection list 32, the text-based description 15 with the language text 15′ may be generated in a voice generation S13 step from the selection list 32, or using the selection list 32 by means of a text generation apparatus 35. The text generation 35 may be an algorithm of natural language generation (NLG) as is known from the prior art. Language generation rules 36 may be provided for this in the text generation apparatus 35 which provide ready-made text fragments 37 that contains text gaps 38 which may be filled in or replaced with the name of a route feature 24 that is currently to be described.

The described voice output 17 and/or the written description 18 then occur in an output step S14.

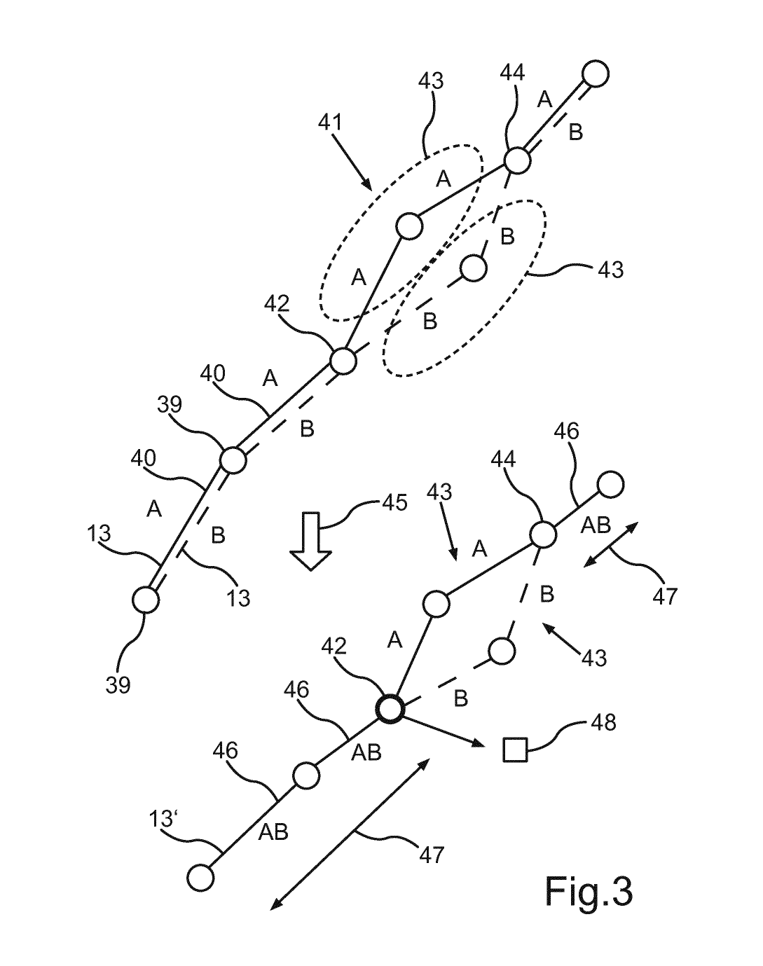

FIG. 3 illustrates how two routes A, B may be combined so that a common description is feasible with the emphasis of differences between the routes A, B. A separate description of the two routes A, B is first shown by means of a respective graph 13 that may have nodes 39 and edges 40 in a manner known per se. Only some of the nodes 39 and edges 40 are provided with reference numbers for the sake of clarity. A difference 41 between the course of route A and route B results at a split node 42 at which a common course of the routes A, B is terminated or interrupted, and different route sections 43 result for the two routes. Once the two routes A, B resume a common course, a join node 44 results.

By means of a joining or graph reduction 45 of the two graphs 13, common edges 40 may each be joined into a combined edge 46.

This yields sequences 47 of a common course of the routes A, B which is illustrated in FIG. 3 by the designation AB. The separate or different route sections 43 that are clearly discernible in the reduced graph 13′ result at the split node 42.

When producing a description 15 for the two routes A, B, the sequences 47 may be described once and a difference note 48 may be output in the description 15 at a split node 42 so that the reader or hearer of the description 15 is notified that two separate or different route sections 43 follow.

The reduced graph 13′ provides automated production of a compact, text-based description 15 with language text 15′ for two or more than two routes.

The route combination is hence created using the following four steps:
1. Data aggregation—step S10:

Data are aggregated from various sources for the combination of a route. This includes for example:
1. Roads and the distance that they take on the route as well as the compass direction in which the respective part of the route runs;
2. Locations, their distance and orientation (such as “on the right side” or “to the north”) relative to the route;
3. POIs (points of interest), as well as their distance and orientation relative to the route;
4. Visited points of interest from social networks (such as Facebook® Foursquare®, Yelp®) as well as personal points of interest from locally learned destinations, from movement history, from the address book and their distance and orientation relative to the route;
5. Maneuvering points of the route, and
6. Distance at the anticipated arrival time at these points.
2. Data selection—step S11:

From this totality of route information, a parameterized selection is then made. The selection of the selection criterion 30 can provide at least one of the following aspects:
RE: 1: Selection using minimum route distance coverage in order to prefer roads on which much time and distance is taken over shorter and assumedly unimportant road sections; selection by the road type (such as preference of freeways and highways). Moreover, the selection of roads can be terminated when an aggregated maximum coverage (such as ⅔ of the route distance) is achieved.
RE: 2: Selection using the size/relevance of the locations; selection by the distance to the route for distinguishing between trips passing by the location and trips passing directly through.
RE: 3/4: Selection using a POI category or a datum from the last

personal visit.
RE: 5: Support the other selections in order to cover important maneuvering points,

for example in that locations are selected at which a highway changes.
RE: 6: Uniform information selection along the course of the route to

prevent only the end of the route from being described for example when driving from a rural area into a large city.

The specific parameters of the selection can be supported by personalization, movement history, personal preferences and search histories.
3. Sorting—step S12:

The selected information is then sorted using the temporal sequence along the route. Moreover, locations, points of interest and maneuvering points (2.-5.) can be assigned to selected roads (1.) when for example a location on the route (2.) is traveled through on a selected road (1.). The result of this step is a selection list of information between which a selection hierarchy (such as location/road) may result. In addition, it is also useful to restrict the number of pieces of information so that the description does not run the danger on longer routes of becoming too detailed and too descriptive. An example would be a restriction to a maximum of three cited roads (1), or a maximum of two locations along the route (2).
4. Natural language generation (NLG)—step S13:

Linguistic text can of course be produced from the produced output list of information in that the hierarchies and the temporal sequences of suitable texts are compiled for each information type. Examples of such texts are:
“go west on the A2 via Magdeburg”,
“then enter Cologne on the A4”,
“take a right at the Berlin Cathedral”,
“then continue through Bielefeld and Dortmund”.

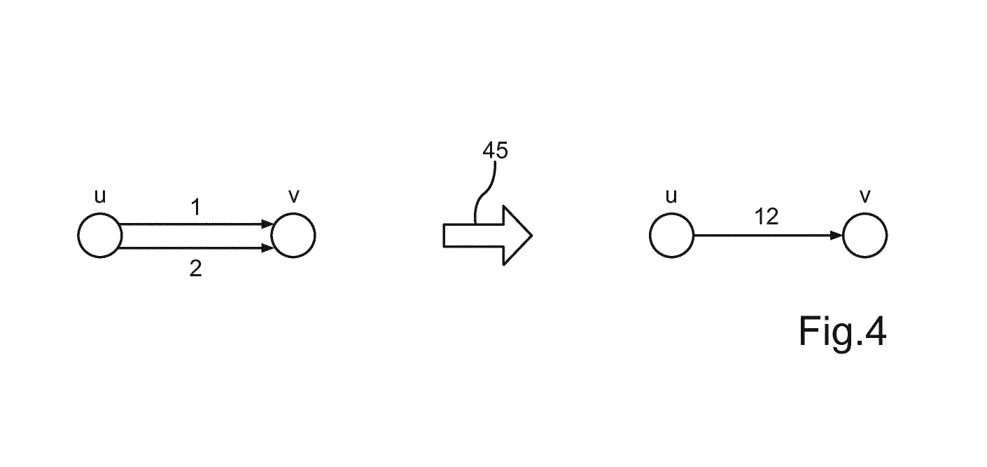

The route comparison is based on two routes with the same starting and ending point (see FIG. 4).
1. Graph production

The segments of a route (i.e., the through road sections) can in this context be interpreted as a directional path between starting and ending nodes. When both route paths are combined, a graph 13′ results with common starting and ending nodes and edges that can each be assigned to a route. In the following, we will be describing using [u,v,i] edges in this graft, wherein u and v describe the nodes of the edge, and i describes the route to which the edge belongs (i=1 for the first route, i=2 for the second route). Moreover, i=12 means that an edge belongs to both routes, i.e., both routes use the same road section.
2. Graph reduction 45 (see FIG. 3 and FIG. 4)

The aim of this step is to combine road sections that are used by both routes. For this, edge pairs as shown in FIG. 4 [u,v, 1] and [u,v,2] (i.e., edges that only differ in terms of the association with the route, but not however in terms of the nodes) are replaced by a single edge [u,v,12]:

The reduced graph 13′ then has the following properties:
if a node has more than one outgoing edge, they are labeled differently (split);
if a node has more than one incoming edge, they are labeled differently (join);
if a node has more just one incoming and just one outgoing edge, they are labeled the same (sequence).
3. Natural language generation (NLG) by the text generation apparatus 35:

Natural language text may be produced from the graph 13′ as follows:
sequences are treated like routes, and text is produced corresponding to the previously-described method for route description. Using the labeling, this text either refers to a certain route (i=1 oder i=2) or to both routes (i=12).
at splits, route sections differ from each other, and at joins, sections of different routes come together. Texts may be correspondingly inserted; for example: “Route 1 then runs through . . . , whereas route 2 runs through . . . ” for a split, or for example “then both routes run through . . . ” for a join.

By corresponding parameterization, it may be monitored whether each route section should be described, or for example very short sections should be ignored.

In particular, the following aspects are beneficial for a route description:
parameterized approach for producing route descriptions which allows adaptation to user preferences. Both the detail as well as the contained types of information (cities, roads, points of interest) can be configured. Moreover, a different route description can be produced for different applications (such as text description or voice output).
a route description beyond one to two road names provides the user with the necessary “vocabulary” for further interaction, such as “are we also driving on the A10?”, “When will we be in Wolfsburg?”. Moreover, a natural language route description simplifies the dialog since the route description can be announced for example on a telephone.
in addition, a natural language route description allows a better understanding of other sources (such as traffic instructions on the radio, road signs, guidance announcements) since they can be “recognized” by the previous route description.

In particular, a route difference is beneficial:
there are different scenarios in which routes can be compared with each other: (1) different cost functions (fastest versus most economical route); (2) explicit replanning of the route by inserting an intermediate destination; (3) replanning the route to drive around a traffic obstruction. A compact description of the differences from the previous route is useful for the driver in all of these scenarios.
the route difference can also be used for optimization in that for example points of interest are only searched on the changed, newly driven route section instead of repeating this on the overall route.

Examples of route descriptions that can be produced by means of the method:
for the section from Berlin to Wolfsburg: “The route is 216 km long and lasts 2 and one quarter hours. It runs in a westerly direction on the A2 via Burg, Magdeburg and Hohe Börde.”
for a section within Berlin: “The route is 6 km long and lasts 13 minutes. It runs on Altonaer Road, June 17 Road, and then takes a right at the Brandenburg Gate”.

Route difference:
starting from the route from Berlin to Wolfsburg, with the route subsequently re-planned to avoid highways: “(1) The new route is 14 km shorter and lasts 48 minutes longer. (2) The route first runs on Cauerstraße, Bismarckstraße and Kaiserdamm. (3) The previous route runs on the A2 via Magdeburg, Hohe Börde and Helmstedt. The new route goes toward Nauen, then on the B188 via Stendal and Gardelegen. (4) The route then continues on Rothenfelder Road and Kleiststraße.”

route within Berlin from Charlottenburg to Wilmersdorf, then replanned to drive around a closure at Ernst-Reuter-Platz: “(1) The new route is 400 m longer and takes just as long. (2) The route first runs on Carnotstraße, Morsestraße and Dovestraße. (3) The previous route runs via Einsteinufer, Marchstraße and Ernst-Reuter-Platz. The new route runs via Cauerstraße and Leibnitzstraße. (4) The route runs via Uhlandstraße.”

In this case, (1) describes the routes in terms of distance and duration, (2) and (4) describe common route sections, and (3) describes the route sections that differ between the routes.

Possible variations of the described embodiments can for example appear as follows:

Exclusive use of locations, or respectively cities: For the combination of the routes, less information can be used. For example, only locations and cities. This is however a combination that does not help someone unfamiliar with the area since the locations cannot be ascertained from a road like the highway.

Summary of the guidance announcements:

The guidance announcements of the route may be used as a foundation for the route description/difference. Without a suitable aggregation and differentiation, this however corresponds to the simulated departure of the route as is offered by some navigation systems. However, this is not a solution that quickly and efficiently offers an overview of a route, or respectively a difference. Consequently, the described graph reduction offers particular advantages.

More types of information are possible. Such cases can be realized by suitable parameterization of the method. Knowledge trained by the user can be used.

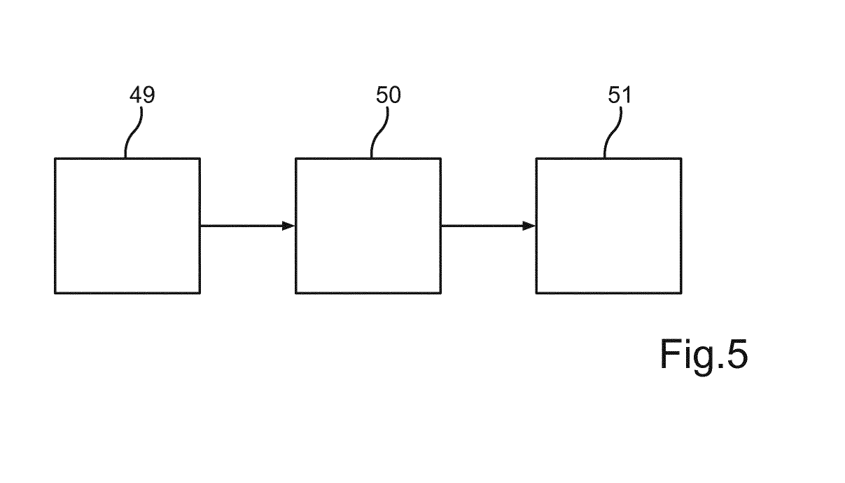

FIG. 5 illustrates how route guidance can be provided in a motor vehicle without the above-described “gap”. A user can enter a destination entry 49 for example by text or voice into the navigation apparatus 11. Instead of a graphic route display, the described text-based description 15 can be realized as a route output 50. Navigation assistance 51 then follows which can produce the navigation instructions by voice or text.

Overall, the example shows how an algorithmic route combination and an algorithmic route comparison is provided by the teachings herein.

### LIST OF REFERENCE NUMBERS

10 Motor vehicle

11 Navigation apparatus

12 Route data

13 Graph

13′ Reduced graph

14 Control device

15 Text-based description

15′ Language text

16 Audio output apparatus

17 Voice output

18 Written description

19 Display unit

20 Communication apparatus

21 Mobile terminal

22 Infotainment system

23 Surrounding area

24 Route feature

25 Road

26 Landmark

27 Corridor

28 Strip

29 Width

30 Selection criterion

30′ Sorting criterion

31 Selected route features

32 Output list

33 Output sequence

34 Output hierarchy

35 Text production apparatus

36 Language production rules

37 Text fragments

38 Text gap

39 Node

40 Edge

41 Difference

42 Split node

43 Route section

44 Join node

45 Graph reduction

46 Combined edge

47 Sequence

48 Difference note

49 Destination entry

50 Route output

51 Navigation assistance

A Route

B Route

S10 Data aggregation

S11 Data selection

S12 Sorting

S13 Language generation

S14 Output

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The mere fact that certain measures are recited in mutually different dependent claims or embodiments does not indicate that a combination of these measured cannot be used to advantage. Any reference signs in the claims should not be construed as limiting the scope.

What is claimed is:

1. A method for providing a text-based description of at least one route for a journey of a motor vehicle, wherein using a control device:
route features are determined in a respective predefined surrounding area comprising the respective route;
by using a predetermined selection criterion, at least some from the determined route features are selected for the description; by using a predetermined sorting criterion, the selected route features are arranged in an output order and an output hierarchy, and are entered into an output list; and
by using a text generating apparatus, a language text is produced from the output list as the description of the at least one route on the basis of predetermined language generation rules and is output to a user.

2. The method according to claim 1, wherein at least one of the following is determined as a route features: a road which the route follows, and a landmark at the road.

3. The method according to claim 1, wherein the selection criterion is parameterizable, and one or more of a level of detail and feature type is established for the selection depending on user input.

4. The method according to claim 1, wherein for the selection of the route features, one or more of a distance to a driving destination and an estimated arrival time at the driving destination is determined for the features, and the selection criterion provides that the selected route features are arranged evenly along the respective route in terms of at least one of location and time.

5. The method according to claim 1, wherein in the sorting criterion, the output orders is a temporal encountering sequence that results from a journey along the respective route, and wherein the output hierarchy hierarchically subordinates landmarks to an adjacent road on the route.

6. The method according to claim 1, wherein the text generation apparatus generates one or more of a written language text for display on a display apparatus and a spoken language text for a voice announcement.

7. The method according to claim 1, wherein the text generation apparatus sequentially processes the route features entered in the output list, and the language generation rules provide prefabricated text fragments with predetermined text gaps, and the current route feature from the output list is inserted into the respective text gap.

8. The method according to claim 1, wherein a description is generated for at least two routes, and the two routes are combined in that a graph is formed which describes the two routes, which two routes represent common route sections as a common sequence of the graph, and such pairs of route sections, of which each belongs to only one of the two routes, are inserted in the graph between a split node and a join node of the graph.

9. The method according to claim 8, wherein using the text generation apparatus, a common language text section for both routes is provided in order to produce the language text for a sequence of the graph, and a difference note is provided for a split node, and an individual language text section is provided in the language text for divided route sections.

10. The method according to claim 8, wherein the comparison of the routes is performed before the start of a navigation assistance for a selection of one of the routes, and after a recalculation of a new route based on a replanning during the navigation assistance.

11. A control device for a motor vehicle, wherein the control device has a processor apparatus that is configured to perform a method according to claim 1.

12. A motor vehicle having a control device according to claim 11.

13. The method according to claim 8, wherein the comparison of the routes is performed before the start of a navigation assistance for a selection of one of the routes, or after a recalculation of a new route based on a replanning during the navigation assistance.

14. The method according to claim 9, wherein the comparison of the routes is performed before the start of a navigation assistance for a selection of one of the routes, and after a recalculation of a new route based on a replanning during the navigation assistance.

15. The method according to claim 9, wherein the comparison of the routes is performed before the start of a navigation assistance for a selection of one of the routes, or after a recalculation of a new route based on a replanning during the navigation assistance.

16. The method according to claim 1, wherein in the sorting criterion, the output orders is a temporal encountering sequence that results from a journey along the respective route, or wherein the output hierarchy hierarchically subordinates landmarks to an adjacent road on the route.

17. The method according to claim 2, wherein a landmark comprises at least one of a location past which the route runs, a user-specific point of interest known to the user, and a maneuvering point on the route at which a road changeover and/or a road fork must be taken into account.
